(19) United States
(12) Patent Application Publication
(10) Pub. No.: US 2007/0206931 A1
(43) Pub. Date: Sep. 6, 2007

(54) MONOCHROME FRAME DETECTION METHOD AND CORRESPONDING DEVICE

(75) Inventors: Mauro Barbieri, Eindhoven (NL); Dzevdet Burazerovic, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 10/599,631

(22) PCT Filed: Apr. 4, 2005
(86) PCT No.: PCT/IB05/51102

§ 371 Date: Oct. 4, 2006

(30) Foreign Application Priority Data
Apr. 8, 2004 (EP) 04300189.0

(51) Int. Cl. H04N 7/32; G06T 5/00; H04N 7/34

(52) U.S. Cl. 386/109; 375/240.01

(57) ABSTRACT

The invention relates to a detection method applied to digital coded video data available in the form of a video stream comprising consecutive frames divided into macroblocks themselves subdivided into contiguous blocks. These frames comprise I-frames, coded independently, P-frames, predicted from a previous I- or P-frame, and B-frames, bidirectionally predicted from at least two frames between which they are disposed. According to the invention, the processing method comprises the steps of determining for each block of the current frame if it has been coded, or not, according to a predetermined intra prediction mode, collecting similar information for all the blocks of the current frame, for delivering statistics related to said intra prediction mode, analyzing said statistics for determining the number of blocks of said current frame which exhibit, or not, said intra prediction mode, and detecting in the sequence of frames, each time said number is greater than a given threshold, the occurrence of an image, or a sub-region of an image, which is either monochrome or with a repetitive pattern.

### FIELD OF THE INVENTION

The invention relates to a method allowing to automatically detect monochrome frames or parts of frames, for example in H.264/MPEG-4 AVC video streams. The method is mainly based on the usage of novel coding parameters introduced by H.264, enabling very efficient and cost-effective detection.

### BACKGROUND OF THE INVENTION

During the recent years, international video coding standards have played a key role in facilitating the adoption of digital video in various professional and consumer applications. Most influential standards have been developed by two organizations: ITU-T and ISO/IEC MPEG, sometimes jointly (for example: MPEG-2/H.262). The newest joint standard is H.264/AVC, which was expected to be officially approved in 2003 by ITU-T as Recommendation H.264/AVC and by ISO/IEC as International Standard 14496-10 (MPEG-4 Part 10) Advanced Video Coding (AVC). The main goals of the H.264/AVC standardization have been to achieve a significant gain in compression performance and to provide a “network-friendly” video representation addressing “conversational” (telephony) and “non-conversational” (storage, broadcast, streaming) applications. Currently, H.264/AVC is broadly recognized for achieving these goals, and it is being considered by technical and standardization bodies, such as the DVB- and DVD-Forum, for use in several future systems and applications. On the Internet, there is a growing number of sites offering information about H.264/AVC, among which an official database of ITU-T/MPEG JVT [Joint Video ‘Team] provides free access to documents reflecting the development and status of H.264/AVC, including the draft updates.

The H.264/AVC syntax and coding tools may be recalled here. First, H.264/AVC employs the same principles of block-based motion-compensated transform coding that are known from the established standards such as MPEG-2. The H.264 syntax is, therefore, organized with the usual hierarchy of headers (such as picture-, slice- and macroblock headers) and data (such as motion vectors, block-transform coefficients, quantizer scale, etc). While most of the known concepts related to data structuring (e.g. I, P, or B pictures, intra- and inter macroblocks) are maintained, some new concepts are also introduced at both the header and the data level. Mainly H.264/AVC separates the Video Coding Layer (VCL), which is defined to efficiently represent the content of the video data, and the Network Abstraction Layer (NAL), which formats data and provides header information in a manner appropriate for conveyance by the higher level (transport) system.

One of the main particularities of H.264/AVC at the data level is also the use of more elaborate partitioning and manipulation of 16×16 macroblocks (a macroblock MB includes both a 16×16 block of luminance and the corresponding 8×8 blocks of chrominance, but many operations, e.g. motion estimation, actually take only the luminance and project the results on the chrominance). So, the motion compensation process can form segmentations of a MB as small as 4×4 in size, using motion vector accuracy of up to one-fourth of a sample grid. Also, the selection process for motion compensated prediction of a sample block can involve a number of stored previously decoded pictures, instead of only the adjoining ones. Even with intra coding, it is now possible to form a prediction of a block using previously decoded samples from neighboring blocks (the rules for this spatial-based prediction are described by the so-called intra prediction modes). This aspect is especially relevant for the invention here defined and will be highlighted later in the description. After either motion compensated- or spatial-based prediction, the resulting prediction error is normally transformed and quantized based on 4×4 block size, instead of the traditional 8×8 size. The H.264/AVC standard still uses other specific realizations in other coding stages (e.g. entropy coding), most of which are fixed or can only be altered at or above the picture level.

As it was the case with the previous standards, H.264/AVC allows an image block to be coded in intra mode, i.e. without the use of a temporal prediction from the adjacent images. A novelty of H.264/AVC intra coding is the use of a spatial prediction, allowing to predict an intra block by a block P formed from previously encoded and reconstructed samples in the same picture. This prediction block P will be subtracted from the actual image block prior to encoding, which is different from the existing standards (e.g. MPEG-2, MPEG-4 ASP) where the actual image block is encoded directly. For the luminance samples, P may be formed for a 16×16 MB or each 4×4 sub-block thereof. There are in total 9 optional prediction modes for each 4×4 block, 4 optional modes for a 16×16 MB, and one mode that is always applied to each 4×4 chroma block, which will not be discussed here).

In the present example, FIG. 1 shows on its left part a 16×16 luminance macroblock and on its right part its 4×4 sub-block being predicted (the samples above and to the left have previously been encoded and reconstructed, and they are therefore available in the encoder and decoder to form a prediction reference). The prediction block P is calculated based on samples, and FIG. 2 shows on its left part labeling of samples constituting the prediction block P (a to p) and the relative location and labeling of the samples (A to M) used for prediction (when pixels E to H are not available, they are substituted by the pixel value of D). The arrows in the right part of FIG. 2 indicate the direction of prediction in each mode. For modes 3 to 8, each of the prediction samples a to p is computed as a weighted average of samples A to M. For modes 0 to 2, all the samples a to p are given a same value, which may correspond to an average of samples A to D (mode 2), I to L (mode 1) or A to D and I to L together (mode 0). The encoder will typically select the prediction mode for each 4×4 block that minimizes the residual between that block (to be encoded) and the corresponding prediction P. Next to the 4×4 prediction, H.264 also allows to predict a 16×16 luma part of a MB as a whole. For this, four possible modes are specified, that are successively shown in FIG. 3. Respectively, they correspond to extrapolation from upper samples, extrapolation from left-hand samples, averaging of upper and left-hand samples, and fitting of a linear “plane” function to the upper and left-hand samples. It should be noted that the choice of the intra mode must also be signaled to the decoder, for which purpose H.264 defines an efficient encoding procedure (its central idea is to avoid separate encoding of the 4×4 modes, by exploiting the observation that the modes of neighboring 4×4 blocks will often be highly correlated).

Recent advances in computing, communications and digital data storage have led in both the professional and the consumer environment to a tremendous growth of large digital archives, characterized by a steadily increasing capacity and content variety. Finding efficient ways to quickly retrieve stored information of interest is therefore of crucial importance.

Since searching manually through terabytes of unorganized stored data is tedious and time consuming, there is a growing need to transfer information search and retrieval tasks to automated systems. Search and retrieval in large archives of unstructured video content is usually performed after the content has been indexed using content analysis techniques. These techniques comprise algorithms that aim at automatically creating, in view of the description of said video content, annotations of video material (such annotations vary from low-level signal related properties, such as color and texture, to higher-level information, such as presence and location of faces).

An important content descriptor is the so-called monochrome, or “unicolour” frame indicator. A frame is considered as monochrome if it is totally filled with the same color (in practice, because of noise in the signal chain from production to delivery, a monochrome frame often presents imperceptible variations of one single color, e.g. blue, dark gray or black). Detecting monochrome frames is an important step in many content-based retrieval applications. For instance, as described in the Patent Application Publication US2002/0186768, commercial detectors and program boundaries detectors rely on the identification of the presence of monochrome frames, usually black, that are inserted by broadcasters to separate two successive programs, or to separate a program from commercial advertisements. Monochrome frame detection is also used for filtering out uninformative keyframes from a visual table of content.

Because of the large application area for the upcoming H.264/MPEG-4 AVC standard, there will be a growing demand for efficient solutions for H.264/AVC video content analysis. During recent years, several efficient content analysis algorithms and methods have been demonstrated for MPEG-2 video, that almost exclusively operate in the compressed domain. Most of these methods could be extended to H.264/AVC, since H.264/AVC in a way specifies a superset of MPEG-2 syntax, as indicated above. However, due to the limitations of MPEG-2, some of these existing methods may not give adequate or reliable performance, which is a deficiency that is typically addressed by including additional and often costly methods operating in the pixel or audio domain.

### SUMMARY OF THE INVENTION

It is therefore an object of the invention to propose a detection method more appropriate and requiring less computation power when compared to conventional detection methods such as the ones based on the analysis of the DCT coefficient statistics.

To this end, the invention relates to a detection method applied to digital coded video data available in the form of a video stream comprising consecutive frames divided into macroblocks themselves subdivided into contiguous blocks, said frames including at least I-frames, coded independently of any other frame either directly or by means of a spatial prediction from at least a block formed from previously encoded and reconstructed samples in the same frame, P-frames, temporally disposed between said I-frames and predicted from at least a previous I- or P-frame, and B-frames, temporally disposed between an I-frame and a P-frame, or between two P-frames, and bidirectionally predicted from at least these two frames between which they are disposed, said processing method comprising the steps of:
determining for each successive block of the current frame if it has been coded, or not, according to a predetermined intra prediction mode;
collecting similar information for all the successive blocks of the current frame and delivering statistics related to said predetermined intra prediction mode;
analyzing said statistics for determining the number of blocks of said current frame which exhibit, or not, said intra prediction mode;
detecting in the sequence of frames, each time said number is greater than a given threshold, the occurrence of an image, or of a sub-region of an image, which is either monochrome or with a repetitive pattern.

Another object of the invention is to propose a detection device for carrying out said detection method.

To this end, the invention relates to a detection device applied to digital coded video data available in the form of a video stream comprising consecutive frames divided into macroblocks themselves subdivided into contiguous blocks, said frames including at least I-frames, coded independently of any other frame either directly or by means of a spatial prediction from at least a block formed from previously encoded and reconstructed samples in the same frame, P-frames, temporally disposed between said I-frames and predicted from at least a previous I- or P-frame, and B-frames, temporally disposed between an I-frame and a P-frame, or between two P-frames, and bidirectionally predicted from at least these two frames between which they are disposed, said device comprising the following means:
determining means, for determining for each successive block of the current frame if it has been coded, or not, according to a predetermined intra prediction mode;
collecting means, for collecting similar information for all the successive blocks of the current frame and delivering statistics related to said predetermined intra prediction mode;
analyzing means, for performing an analysis of said statistics and determining the number of blocks of said current frame which exhibit, or not, said intra prediction mode;
detecting means, for carrying out, in the sequence of frames, a detection of the occurrence of an image or sub-region of an image which is either monochrome or with a repetitive pattern, said detection being performed each time said number is greater than a given threshold.

### BRIEF DESCRIPTION OF THE DRAWINGS

The present invention will now be described, by way of example, with reference to the accompanying drawings in which:

FIG. 1 shows an original 16×16 luminance macroblock (left) and a 4×4 block to be predicted (right);

FIG. 2 illustrates the directional intra prediction of the 4×4 luminance block;

FIG. 3 illustrates four possible 16×16 intra prediction modes in H.264;

FIG. 4 is a block diagram of an implementation of the processing method according to the invention.

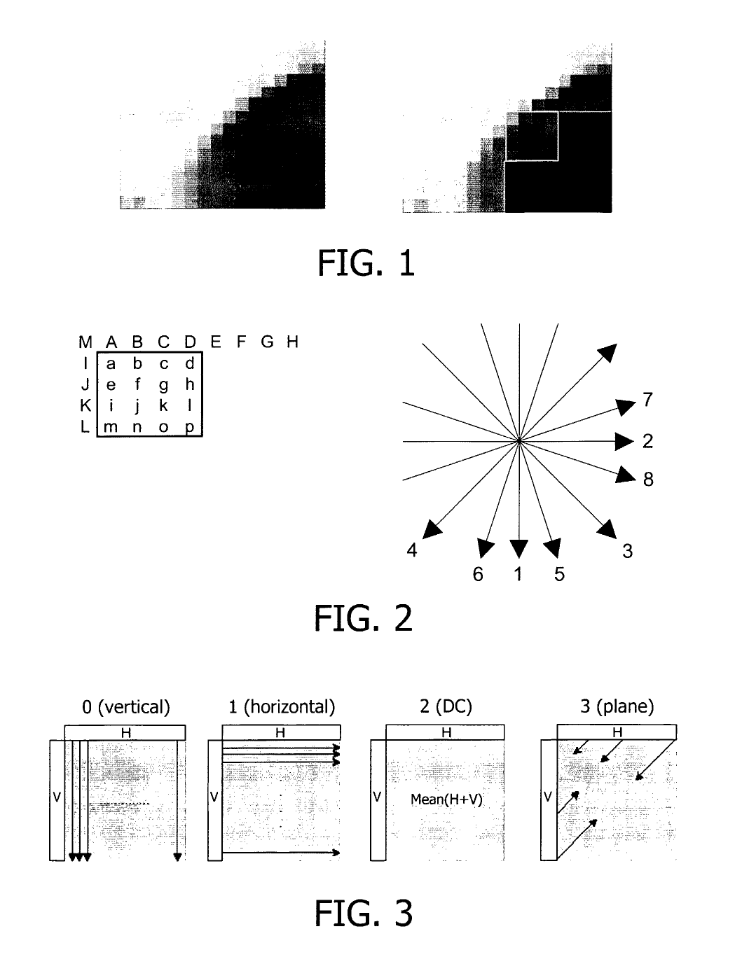

### DETAILED DESCRIPTION OF THE INVENTION

The principle of the invention is based on the fact that intra prediction modes, which are innovative coding tools of H.264/AVC, can be conveniently used for the purpose of monochrome frame detection. The main idea is to observe the distribution of intra prediction mode for (macro-)blocks constituting an image. A monochrome image is detected when most of these blocks exhibit same or similar prediction mode: the number of such blocks can for instance be compared with a fixed threshold. When most of the blocks in the image are encoded according to a certain intra prediction mode, the image presents very low spatial variation, and it is either monochrome or contains a repetitive pattern. For the earlier mentioned application of this algorithm to the generation of the table of content or for keyframe extraction, both these types of images with low or very low spatial variation (monochrome and repetitive pattern) have to be discarded.

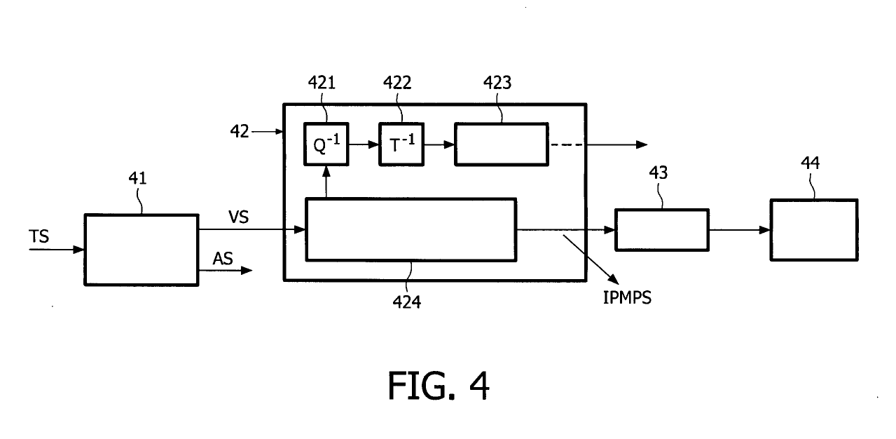

An implementation of the processing method according to the invention is shown in the block diagram of FIG. 4, that illustrates a possible implementation of the proposed monochrome frame detection method, said example being however not a limitation of the scope of the invention. In the illustrated decoding device, a demultiplexer 41 receives a transport stream TS and generates demultiplexed audio and video streams AS and VS. The video stream is received by an H.264/AVC decoder 42, for delivering a decoded video stream DVS. Said decoder 42 mainly comprises an inverse quantization circuit 421 (Q⁻¹), an inverse transform circuit 422 (T⁻¹), which is in the present case an inverse DCT circuit, and a motion compensation circuit 423. It also comprises a so-called Network Abstraction Layer Unit (NALU) 424, provided for collecting the received coding parameters. The output signals of said unit 424 are intra prediction mode parameter statistics IPMPS that are received, for suitable processing, by an analysis circuit 43. The processing operation carried out in this analysis circuit 43 then produces an information about location and duration of monochrome frames in the stream originally received, and this information is then stored in a file 44, e.g. in the form of the commonly used CPI (Characteristic Point Information) table. This output information is now available for many content-based applications such as indicated above (separation of two successive programs or of a program and commercial advertisements, filtering of uninformative keyframes from a table of content, etc).

The main advantage of the method is that it requires less computation power when compared to the traditional detection methods based on the analysis of the DCT coefficient statistics. This is due to the fact that the proposed method requires only partial decoding up to the level of macro-block coding type. A further advantage of said method is that it allows easier detection of frames with little or no information or containing a repetitive pattern (detecting frames with repetitive patterns is not a trivial operation in the pixel/DCT domain). The method can also be used to detect monochrome sub-regions in a frame. An example is the detection of the so-called “letterbox” format, in which an image presents monochrome (e.g. black) bars at its borders.

It must be understood that the present invention is not limited to the afore-mentioned embodiment, and variations and modifications may be made without departing from the spirit and scope of the invention as defined in the appended claims.

It can be noted, for instance, that the words “macroblock” and “block” used in the specification or the claims are not only intended to described the hierarchy of the rectangular sub-regions of a frame, as used in Standards such as MPEG-2 or MPEG-4 for example, but also any kind of arbitrarily shaped sub-regions of a frame, as encountered in encoding or decoding schemes based on irregularly shaped blocks.

It must be noted, also, that there are numerous ways of implementing functions by means of items of hardware or software, or both. In this respect, the drawings are very diagrammatic and represent only one possible embodiment of the invention. Thus, when a drawing shows different functions as different blocks, this by no means excludes that a single item of hardware or software carries out several functions. Nor does it exclude that an assembly of items of hardware or software or both carry out a function.

It can still be indicated that any reference sign in a claim should not be construed as limiting the claim. The word “comprising” does not exclude the presence of other elements or steps than those listed in a claim. The word “a” or “an” preceding an element or step does not exclude the presence of a plurality of such elements or steps.

1. A detection method applied to digital coded video data, comprising:
providing said digital coded video data available in the form of a video stream comprising consecutive frames divided into macroblocks themselves subdivided into contiguous blocks, said frames including at least I-frames coded independently of any other frame either directly or by a spatial prediction from at least a block formed from previously encoded and reconstructed samples in the same frame, P-frames temporally disposed between said I-frames and predicted from at least a previous I- or P-frame, and B-frames temporally disposed between an I-frame and a P-frame or between two P-frames and bidirectionally predicted from at least two frames between which they are disposed,
determining for each successive block of the current frame if it has been coded according to a predetermined intra prediction mode;
collecting similar information for all the successive blocks of the current frame and delivering statistics related to said predetermined intra prediction mode;
analyzing said statistics for determining the number of blocks of said current frame which exhibit said intra prediction mode; and
detecting in the sequence of frames, each time said number is greater than a given threshold, the occurrence of an image, or of a sub-region of an image, which is either monochrome or with a repetitive pattern.

2. A detection method according to claim 1, in which the analysis step is provided for processing the statistics of the intra modes and possible additional coding parameters, and the detecting step is provided for delivering an information about the images or sub-regions of images that are either monochrome or with a repetitive pattern.

3. A detection method according to claim 2, in which information about the location and the duration of said images or sub-images that are either monochrome or with a repetitive pattern is produced and stored in a file.

4. A detection method according to claim 1, in which the syntax and semantics of the processed video stream are those of the H.264/AVC standard.

5. A method for detecting an image or a sub-region of an image either monochrome or with a repetitive pattern in a compressed video stream including consecutive frames, said detecting method comprising:
encoding input digital video data; and
processing said digital coded video data by providing said digital coded video data available in the form of a video stream comprising consecutive frames divided into macroblocks subdivided into contiguous blocks, said frames including at least I-frames coded independently of any other frame either directly or by a spatial prediction from at least a block formed from previously encoded and reconstructed samples in the same frame, P-frames temporally disposed between said I-frames and predicted from at least a previous I- or P-frame, and B-frames temporally disposed between an I-frame and a P-frame or between two P-frames and bidirectionally predicted from at least two frames between which they are disposed, determining for each successive block of the current frame if it has been coded according to a predetermined intra prediction mode; collecting similar information for all the successive blocks of the current frame and delivering statistics related to said predetermined intra prediction mode; analyzing said statistics for determining the number of blocks of said current frame which exhibit said intra prediction mode; and detecting in the sequence of frames, each time said number is greater than a given threshold, the occurrence of an image, or of a sub-region of an image, which is either monochrome or with a repetitive pattern, in order to identify said images or sub-images either monochrome or with a repetitive pattern.

6. A detection device applied to digital coded video data available in the form of a video stream comprising consecutive frames divided into macroblocks themselves subdivided into contiguous blocks, said frames including at least I-frames, coded independently of any other frame either directly or by means of a spatial prediction from at least a block formed from previously encoded and reconstructed samples in the same frame, P-frames, temporally disposed between said I-frames and predicted from at least a previous I- or P-frame, and B-frames, temporally disposed between an I-frame and a P-frame, or between two P-frames, and bidirectionally predicted from at least these two frames between which they are disposed, said device comprising:
determining means, for determining for each successive block of the current frame if it has been coded according to a predetermined intra prediction mode;
collecting means for collecting similar information for all the successive blocks of the current frame and delivering statistics related to said predetermined intra prediction mode;
analyzing means for performing an analysis of said statistics and determining the number of blocks of said current frame which exhibit said intra prediction mode; and
detecting means for carrying out, in the sequence of frames, a detection of the occurrence of an image or sub-region of an image which is either monochrome or with a repetitive pattern, said detecting being performed each time said number is greater than a given threshold.

7. (canceled)
